(19) United States
(12) Patent Application Publication
(10) Pub. No.: US 2017/0112098 A1
(43) Pub. Date: Apr. 27, 2017

(54) MODULAR PET FURNITURE HAVING A SPIRAL STRUCTURE

(71) Applicant: CHIH-CHING LEE, Taipei City (TW)

(72) Inventor: CHIH-CHING LEE, Taipei City (TW)

(21) Appl. No.: 14/923,412

(22) Filed: Oct. 26, 2015

(51) Int. Cl. A01K 15/02

(52) U.S. Cl. CPC A01K 15/024

(57) ABSTRACT

A pet furniture includes a connecting member, a board member, a base, a plurality supporting member, a positioning member and an engaging rod. The connecting member has a though hole portion and a plurality channel and engages with the engaging rod, the board member and the positioning member. The engaging rod secured the board members and the connecting members onto the base, and the supporting member can provide support between the base and the board member.

### BACKGROUND OF THE INVENTION

1. Field of the Invention

The present invention relates to a pet furniture, and more particularly to a modular pet furniture having a spiral structure.

2. Description of Prior Art

Pets can bring joy and give companionship to our daily life. One of the most common pet is cat, and they have been human's pet for a very long time.

Some of pet's nature habits are like grinding claws, jumping, climbing or nest in a small space, so some pet owners arrange some ladders, platforms in the environment to allow pets to have different activities.

Somehow due to the limitations of the environment, sometimes some miniature furniture for pets are very desirable for the pet owners.

Therefore, it is desirable to provide a pet furniture to mitigate and/or obviate the aforementioned problems.

### SUMMARY OF THE INVENTION

In order to achieve the above-mentioned objective, a pet furniture is provided, and the pet furniture includes a connecting member, a board member, a base, a plurality supporting member, a positioning member and an engaging rod. The connecting member has a though hole portion and a plurality channel and engages with the engaging rod, the board member and the positioning member. The engaging rod secured the board members and the connecting members onto the base, and the supporting member can provide support between the base and the board member.

### BRIEF DESCRIPTION OF THE DRAWINGS

FIG. 1 is a perspective drawing for an embodiment of the present invention.

FIG. 2 is an exploded view of the embodiment of the present invention.

FIG. 3 is a schematic drawing of the connecting member of the embodiment of the present invention.

FIG. 4 is a cross-sectional drawing of the embodiment of the present invention.

FIG. 5 is a schematic drawing showing the embodiment being attached onto a wall according to the present invention.

FIG. 6 is a schematic drawing of the bridge set according the embodiment of the present invention.

FIG. 7 is a schematic drawing showing the combination of two pet furniture connected by a bridge set according to the embodiment of the present invention.

### DETAILED DESCRIPTION OF THE INVENTION

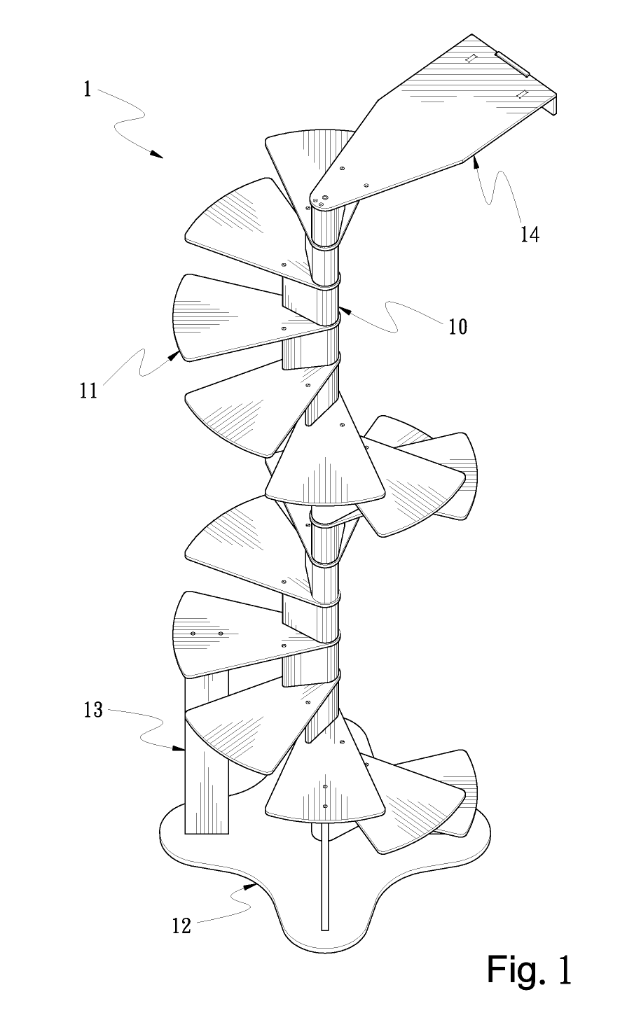

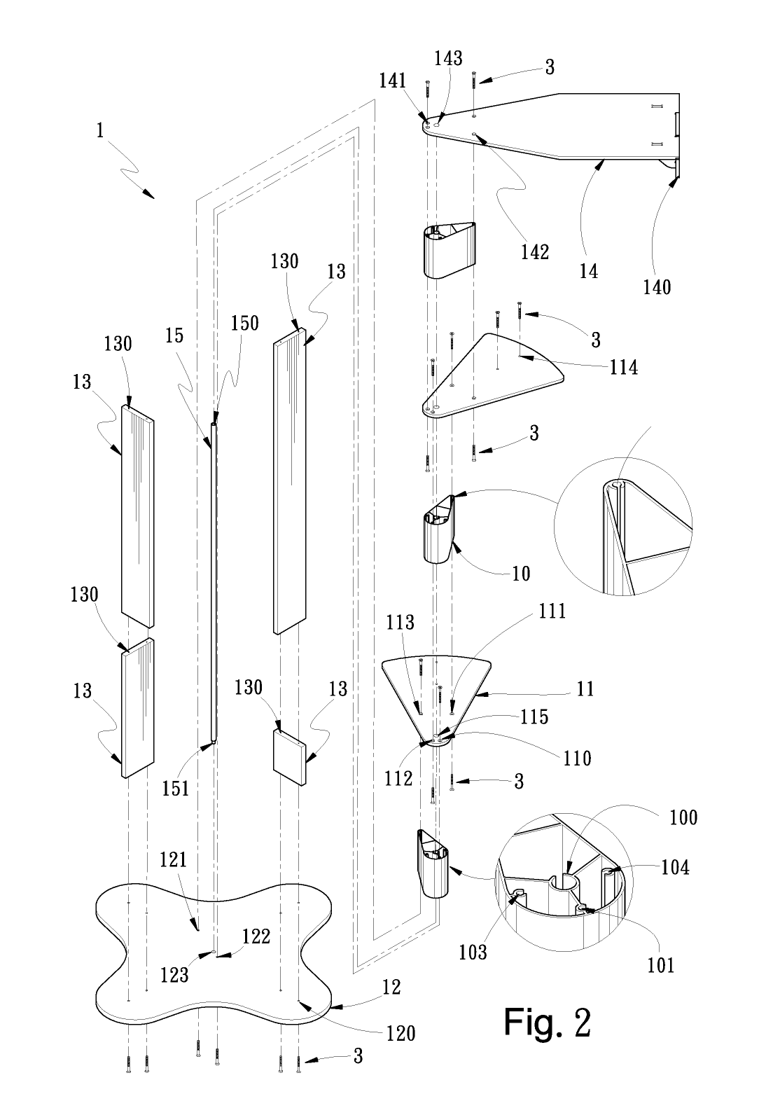

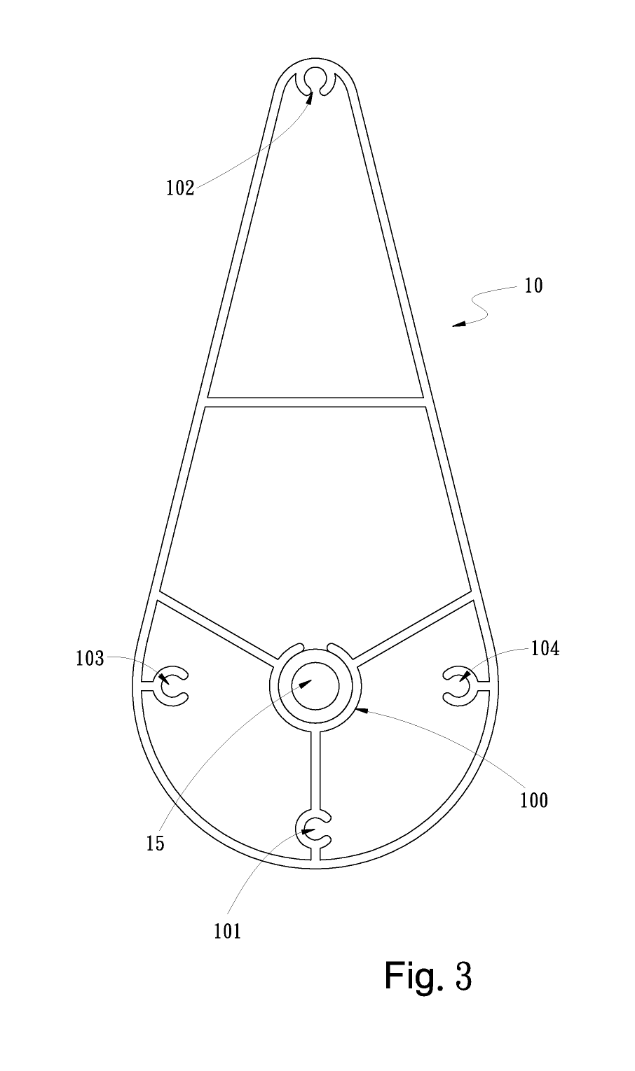

Please refer to FIG. 1, FIG. 2 and FIG. 3. A pet furniture 1 comprises a connecting member 10, a board member 11, a base 12, the plurality supporting member 13, a positioning member 14 and an engaging rod 15.

As shown in FIG. 3, the connecting member 10 is an aluminum extruded piece and has four channels 101, 102, 103 and 104 evenly surrounding a through portion 100. Furthermore, three of the four channels 101, 103, 104 and the through portion 100 are disposed at one end, and one channel 102 is disposed at the other end. The through portion 100 is configured for accepting the engaging rod 15. The channels 101, 102, 103 and 104 of the connecting member 10 are configured for alternatively engaging with the board member 11 and the positioning member 14. For example, as shown in FIG. 2, the channel 101 of the connecting member 10 is aligned and secured with the first engaging aperture 110 of the board member 11 and the first engaging aperture 112 of another board member 11 via screws 3, and the channel 102 of the connecting member 10 is aligned and secured with the first engaging aperture 111 of the board member 11 and the first engaging aperture 113 of another board member 11 via screws 3.

The connecting members 10 can be stacked in a spiral arrangement and the board members 14 correspondingly matches the rotation of spiral arrangement. Furthermore, the channel 101 and the channel 102 of the last connecting member 10 is secured with the engaging aperture 141 and the engaging aperture 142 of the positioning member 14 via screws 3.

The board member 11 is fan-shaped and has a through aperture 115 and five first engaging apertures 110, 111, 112, 113 and 114. The through aperture 115 is identical and aligned with the through portion 100 of the connecting member 10. and the engaging rod 15 is places through both of the through portion 100 and the through aperture 115. The first engaging aperture 110 or the first engaging aperture 112 is aligned and secured with the channel 101 of the connecting member 10 via screws 3, and the first engaging aperture 111 or the first engaging aperture 113 is aligned and secured with the channel 102 of the connecting member 10 via screws 3. The first engaging aperture 114 is aligned and secured with a securing aperture 130 of the supporting member 13, and the supporting member 13 is secured onto the base 12.

The base 12 is a flat base and has a plurality of through apertures 120, 121, 122 and a threaded hole 123. The through apertures 121, 122 are aligned and secured with the channel 101 and the channel 102 of the very bottom connecting member 10 and the threaded hole 123 is configured for being aligned and secured with the screw stem 151 of the engaging rod 15. Moreover, every two through apertures 120 are set as a pair arranged at different locations, and configured for being aligned and secured with securing aperture 130 of the supporting member 13.

The supporting members 13 are boards with different heights suitable for different number of stacked board member 11. The supporting member 13 respectively has two securing aperture 130 at an top end and a bottom end, which are respectively aligned and secured with the engaging aperture 114 of the board member 11 and the through aperture 120 of the base 12 via screws 3. Furthermore, the supporting member 13 can be wrapped with rope for pets to grind their claws.

The positioning member 14 is mounted onto the top connecting member 10, has a mounting portion at 140 one end configured to attach to a wall and a plurality of second engaging apertures 141, 142, 143 . . . are disposed at another end. The engaging aperture 141 and the engaging aperture 142 are aligned and secured with the channel 101 and the channel 102 of the connecting member 10 via screws 3. Another engaging aperture is corresponding, aligned and secured with the threaded aperture 150 of the engaging rod 15 via the screws 3. The mounting portion 140 is securely mounted onto a wall 2.

The engaging rod 15 is a vertical rod, the top end is a screw stem 151 and the bottom end is a threaded aperture 150. The screw stem 151 correspond with threaded hole 123 of the base 12, the threaded aperture 150 corresponds with the engaging aperture 143 of the positioning member 14. Furthermore, each engaging rod 15 is suitable for being engaged with four connecting members 10 and three board members 11. Multiple engaging rods 15, connecting members 10 and board members 11 can be combined to form the pet furniture 1 with a spiral structure.

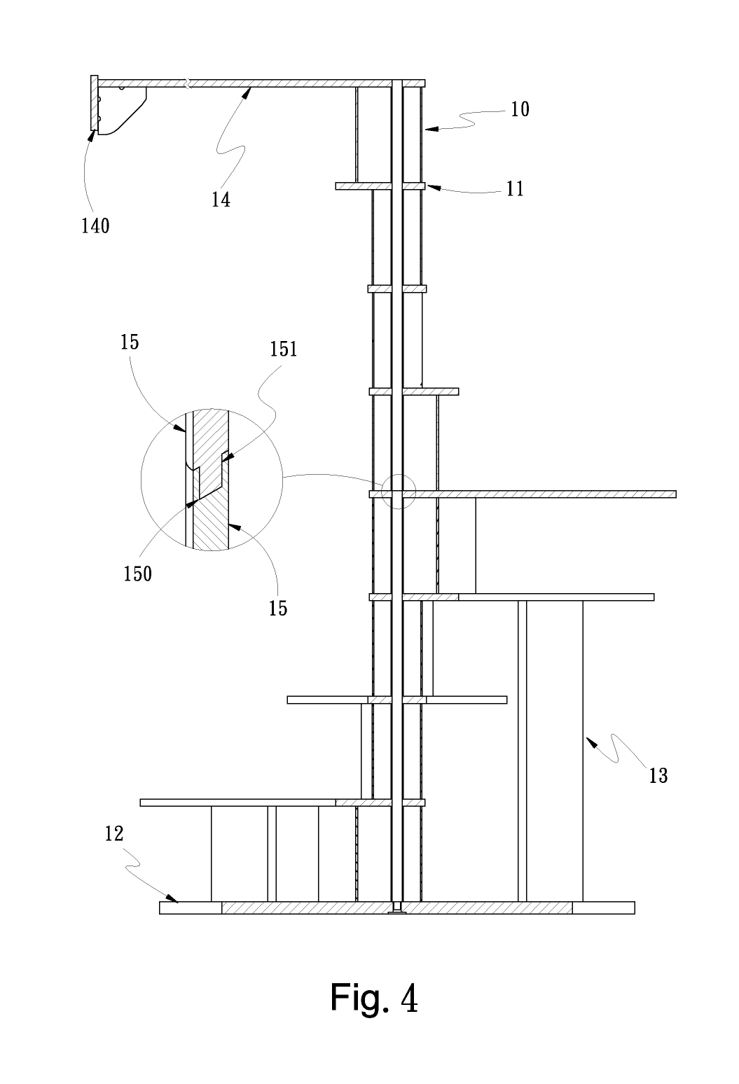

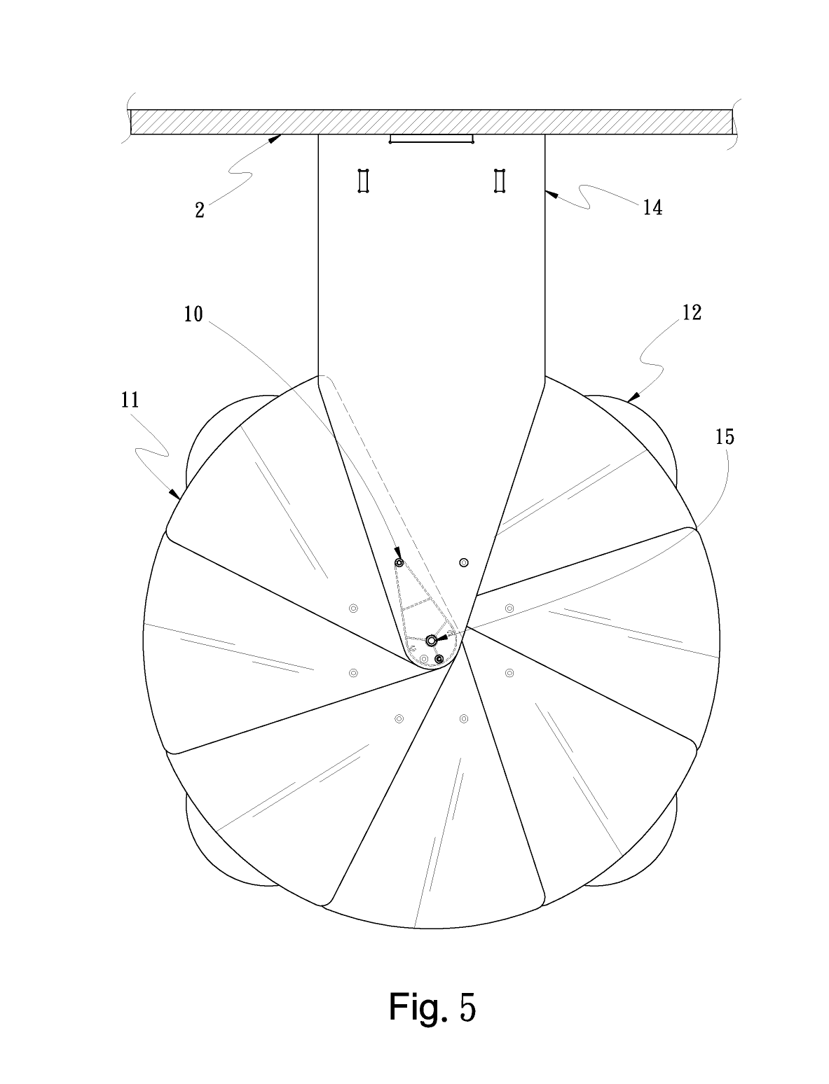

Please refer to FIG. 4 and FIG. 5 again. By stacking the connecting members 10 and the board member 11 of the pet furniture 1, four connecting members 10 and three board members 11 are stacked around the though hole portion 100 of the connecting member 10, and the channel 101 and the channel 102 are secured onto one side of the board member 11. The last connecting member 10 is secured with the positioning member 14, and the mounting portion 140 of the positioning member 14 is secured onto the wall 2. Therefore, the pet furniture 1 can be secured onto the wall 2 for better and stronger support.

Moreover, the connecting members 10, the board members 11 and the engaging rods 15 can be combined for a higher set. When the screw stem 151 of the first engaging rod 15 engages with the threaded aperture 150 of the second engaging rod 15, the number of the connecting members 10 and the board members 11 can be doubled.

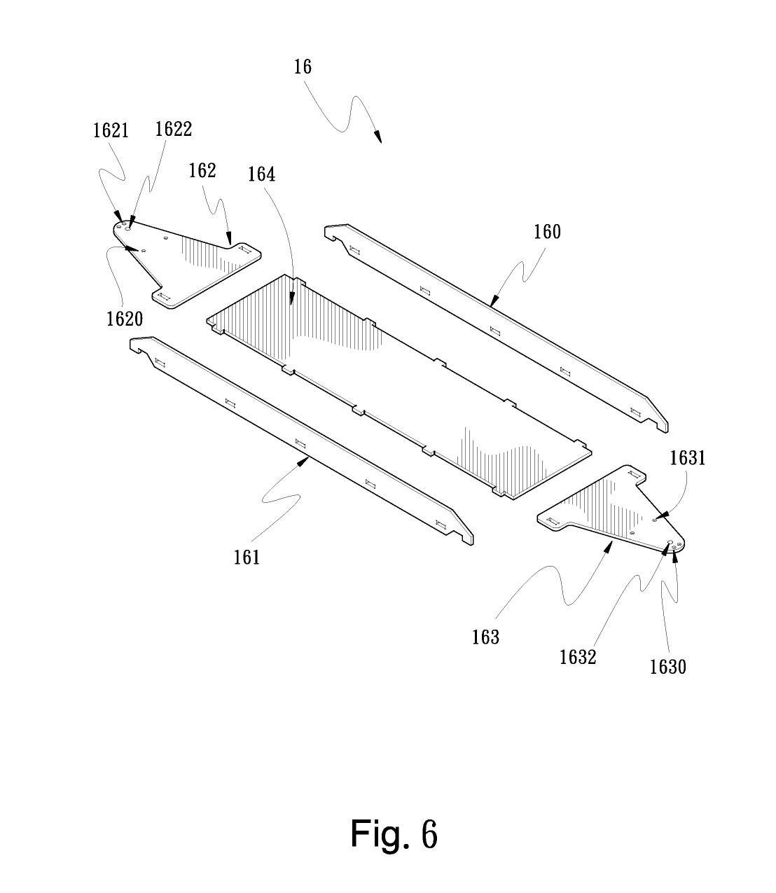

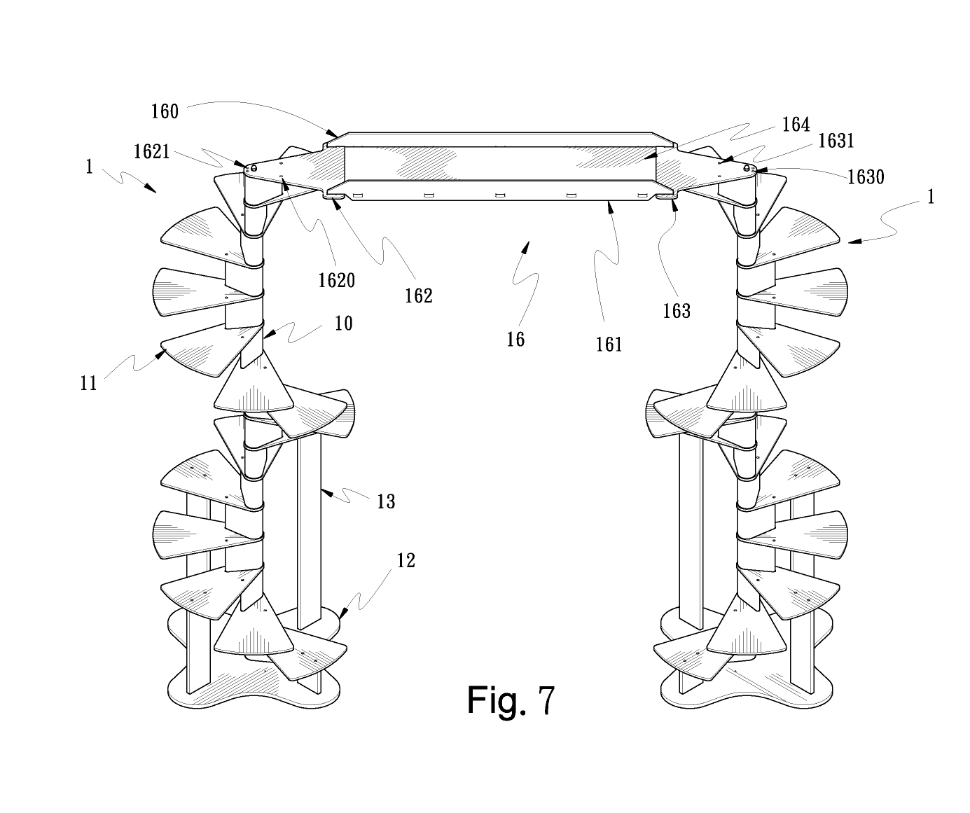

Please refer to FIG. 6 and FIG. 7. Two set of pet furniture 1 can be connected together by the bridge set 16. The bridge set 16 is composed of a first board member 160, a second board member 161, a third board member 162, a fourth board member 163, a fifth board member 164. The third board member 162 and the fourth board member 163 respectively have a plurality of third engaging apertures 1620, 1621, 1622 and 1630, 1631 and 1632. The third engaging aperture 1620 and the third engaging aperture 1621 of the third board member 162 and the third engaging aperture 1630 and the third engaging aperture 1631 of the fourth board member 163 are aligned and secured with the channel 101 and the channel 102 of the connecting member 10. Furthermore, the third engaging aperture 1622 and the third engaging aperture 1632 are respective aligned and secured with the threaded apertures 150 of the two engaging rod 15.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A modular pet furniture comprising: at least one connecting member, at least one board member, a base, at least one supporting member, a positioning member and at least one engaging rod, characterized in that:
the connecting member has a though hole portion and a plurality of channels separately disposed at two ends of the connecting member, the though hole portion corresponding to the engaging rod, the channels of the connecting member respectively connectable to the board member or the positioning board;
the board member has a plurality of first engaging apertures and a through aperture, at least two of the first engaging apertures of the board member securely connectable with at least two channels of the connecting member, and the through aperture corresponds to the engaging rod;
the base has a plurality of securing apertures and a threaded aperture, the securing apertures respectively connectable with the channels of the connecting member and the supporting member;
the supporting member is securely installed between the base and the board member;
the positioning member has a mounting portion at one end configured to attach to a wall, and a plurality of second engaging apertures are disposed at another end, at least two of the second engaging apertures engage with the channels of the connecting member and at least one of the second engaging apertures connects with the connecting rod; and
the connecting rod is configured for insertion through the connecting member and the board member, a top end of the connecting rod engaging with a third engaging aperture of the positioning member, and a bottom end of the connecting rod engages with the threaded aperture of the base.

2. The modular pet furniture as claimed in claim 1, wherein by repeatedly connecting four board members, four connecting members and one connecting rod, a spiral modular structure is achieved.

3. The modular pet furniture as claimed in claim 1, wherein at least two channels of the connecting member correspond to the first and second engaging apertures of the board member and the positioning member.

4. The modular pet furniture as claimed in claim 1, wherein the top end and the bottom end of each connecting rod are securely connectable to each other.

5. The modular pet furniture as claimed in claim 1 further comprising a bridge set, wherein the bridge set has a first pair of boards, a second pair of boards, and a third board engaging among each other; the second pair of boards is capable of respectively connecting to the connecting member and the engaging rod.

6. The modular pet furniture as claimed in claim 3, wherein the second pair of boards respectively have a plurality of third engaging apertures corresponding to the channels of connecting member and the engaging rod.
